(19) United States
(12) Patent Application Publication
(10) Pub. No.: US 2008/0175655 A1
(43) Pub. Date: Jul. 24, 2008

(54) Supporting Framework Comprising Connection Nodes and Struts, Connection Nodes, Connection Element for Producing a Diagonal Connection between a Connection Node and Struts of a Supporting Framework, and Connection Element for Producing a Holding Device for a Flat Element

(75) Inventor: Michael Daubner, Stuttgart (DE)

Correspondence Address: HARNESS, DICKEY & PIERCE, P.L.C., P.O. BOX 828, BLOOMFIELD HILLS, MI, 48303, US

(73) Assignee: Burkhardt Leitner Constructiv GMBH & CO.KG, Stuttgart (DE)

(21) Appl. No.: 11/883,857

(22) PCT Filed: Jan. 10, 2006
(86) PCT No.: PCT/EP06/00131

§ 371 Date: Aug. 7, 2007

(30) Foreign Application Priority Data
Feb. 16, 2005 (DE) 10 2005 009172.5

(51) Int. Cl. F16S 3/08

(52) U.S. Cl. 403/172

(57) ABSTRACT

A supporting framework with connection node and struts has at least two strut receiving elements, each strut receiving element being arranged centrally on an imaginary cube face of the connection node. Arms extend from the strut receiving elements and run parallel to the edges of the imaginary cube face and extend up to an edge of the imaginary cube face that is perpendicular to the arms. The arms of one strut receiving element meet arms of an adjacent strut receiving element arranged orthogonal thereto and form at least one loop. A connection element can be hooked into the loop for producing a diagonal connection.

The invention relates to a supporting framework having a connection node and struts, a connection node, a connection element for producing a diagonal connection between a connection node and struts of a supporting framework, and a connection element for producing a holding device for a flat element in accordance with the preambles to the independent claims.

Supporting frameworks of the type addressed herein have been known for a long time. They connect profiles, called supporting elements, to one another such that a framework structure or a supporting framework results, into which for instance wall elements or shelf elements can be placed. Such supporting frameworks represent a secure connection of elements that can be plugged in and are therefore particularly suitable for the field of exhibition construction and shelf construction. However, the loadability of known types of supporting frameworks is limited.

It is therefore the object of the invention to create a supporting framework that is suitable for producing statically stable surfaces or wall elements.

This object is inventively attained using the features of the independent claims.

In accordance with the invention, a supporting framework having a connection node and struts is suggested, and a connection node is suggested, the connection node having at least two strut receiving elements that are each arranged centrally on an imaginary cube face of the connection node. Extensions in the form of arms extend from the strut receiving elements and run parallel to the imaginary edges of the imaginary cube face and extend to an edge of the imaginary cube face that runs perpendicular to the arms. The arms preferably also extend parallel to the cube face. Each arm of a strut receiving element meets an arm, arranged orthogonal thereto, of an adjacent strut receiving element on the orthogonally arranged cube face and forms at least one loop. Preferably at least six strut receiving elements are provided, each with arms running cross-wise. For producing a diagonal connection in a surface mounted by connection node and struts, a hook-shaped connection element can be hooked into the at least one loop of the connection node and another hook-shaped connection element can be hooked into the loop diagonally opposite thereto. A connection between the connection node and the struts is thus advantageously stabilized by diagonal struts, and it is possible to construct statically stable surfaces and also bearing elements with high load carrying ability using this construction. For instance, self-supporting elements having a length of up to about 10 m can be produced. The hook-shaped connection element can be provided for attaching a mountable diagonal strut. The inventive supporting framework is thus suitable preferably for covers, but also for racks and other loadable surfaces.

Preferably largely round strut receiving elements, each having four arms distributed uniformly on the circumference, are arranged on each imaginary cube face of the connection node so that the connection node has a total of six strut receiving elements, the arms of which meet the adjacent arms arranged orthogonal thereto, forming a total of twelve loops. The connection node is thus not only esthetically pleasing, but also is suitable for numerous combination options for supporting frameworks, for instance also in combination with a wall holder.

The hook-shaped connection element can usefully be brought into a self-locking connection that when loaded can be placed under tension. With this design it is possible to attain in particular diagonal bracing. An inventive connection element includes at least one hook element, one tensioning sleeve, and one fixing element. For stabilizing the connection, the hook element can be provided with a barb, so that the hook-shaped connection element locks in the loop. It can also be provided that the arms that meet one another orthogonally maintain a distance from one another that is preferably smaller than a diameter of the hook.

The distance is for instance 2 to 3 mm. Further retention of the hook in the loop can be obtained by shaping the hook appropriately, for instance as a catch.

At its free end that faces away from the connection node when assembled, the hook element preferably has a receiving opening into which the diagonal strut can be inserted. The diagonal strut is preferably made of wire, so that particularly advantageous tensile strength can be attained. However, it can also be provided that the diagonal strut is embodied as a rod, for instance a telescoping rod, or another support element of a known type. It is particularly preferred when, at each of its free ends, the diagonal strut has an expansion, for instance in the form of a cap pressed on both sides that when assembled locks in the correspondingly embodied receiving opening of the hook element. The connection element and the diagonal strut can be connected by means of the tensioning sleeve for fixing this connection. The holding force of conventional tensioning sleeves advantageously does not become weaker, even when used frequently and under heavy loads, so that it is thus possible to produce a stable connection. Especially in exhibition construction these criteria are critical because exhibition stands are put together and taken apart so frequently. In order to facilitate assembly, the surface of the tensioning sleeve can be provided with a grip structure. Then the connected elements can be enclosed in a fixing element, for instance a fixing tube, preferably made of plastic, which provides additional protection against undesired spontaneous loosening.

The hook-shaped connection element can also be provided for receiving a holding device, for instance for a flat element, in particular a wall element. In this preferred embodiment, the hook-shaped connection element is embodied as a wall plate holder. However, any other suitable material such as fabric, films, hard fillings, glass, or the like can also be held in the holding device. The connection element is preferably designed such that after being hooked in the loop it is self-supporting in order to facilitate assembly of the flat elements. The holding device embodied as wall plate holder can for instance be embodied as a plate holding hook and includes a hook element that can be hooked into the loops of the connection node and a first disk-shaped element, for instance a plastic disk, arranged on the opposing free end of the connection element. A second disk-shaped element, for instance a screw-in tensioning sleeve, is usefully provided for producing a clamping apparatus for a wall element, whereby the wall element can be clamped and fixed between the first disk-shaped element and the screw-in tensioning sleeve.

An inventive connection element for producing a holding device for a wall element includes at least one hook element and a first disk-shaped element that in conjunction with a second disk-shaped element embodies a holding device for a wall element.

The disk-shaped elements have in particular a central bore for receiving a connection means. Plastic disks and spacers can be provided for fixing and stabilizing the wall element clamped between the disks. It is particularly preferred when the second disk-shaped element has a longitudinal hole, so that stabilization of the elements in all directions like an adapter can be advantageously attained.

With the present invention it is possible to produce, with no tools, a pretensioned, stable supporting framework system that is capable of bearing a load and that can be combined and expanded as desired with standardized connection elements, like a modular system.

All connection elements can be produced easily with a conventional punch and bending process so that it is possible to keep production costs low. To the extent possible, all struts and diagonal struts are made of aluminum to enable light-weight construction and to reduce the total weight of the supporting framework. The other elements are preferably made of high quality stainless steel casting. The supporting framework is very light-weight and when taken apart occupies very little volume, which has a positive effect on transportability. Additional embodiments, aspects, and advantages of the invention also result independent from their inclusion in claims, without limiting the generality using exemplary embodiments of the invention depicted in the drawings.

The invention is explained in greater detail in the following using the drawings.

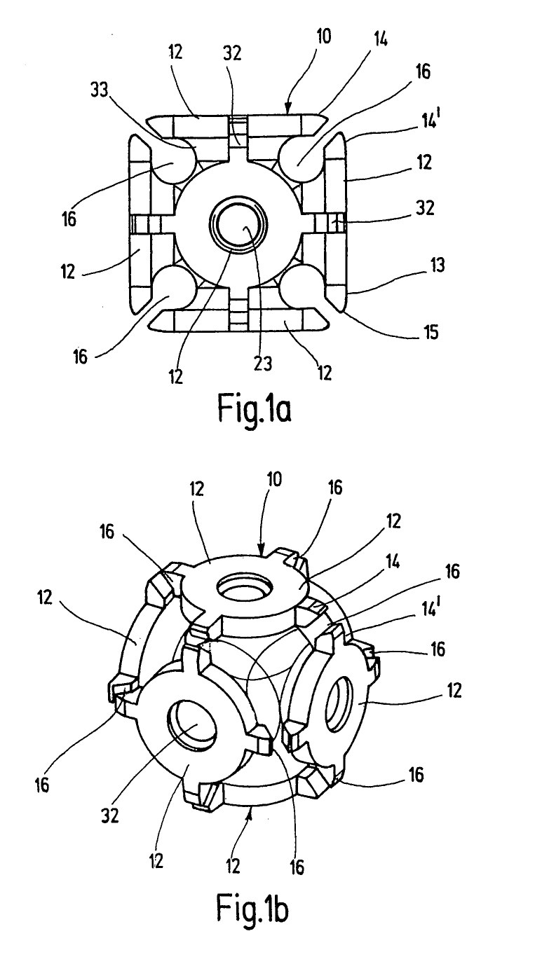

FIGS. 1a,b depicts a section through an inventive connection node (FIG. 1a) and a perspective depiction of the connection node (FIG. 1b);

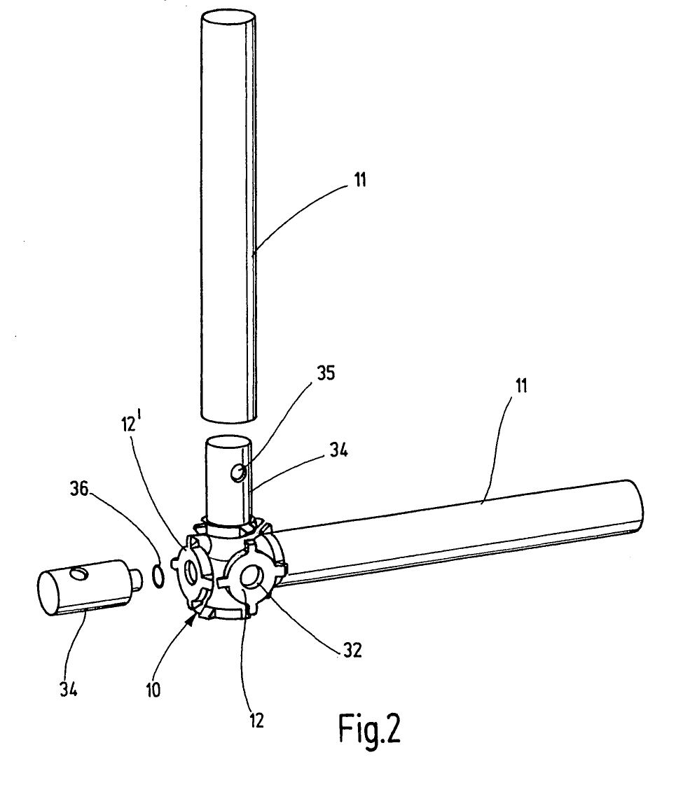

FIG. 2 depicts one embodiment of the inventive supporting framework with connection nodes and struts;

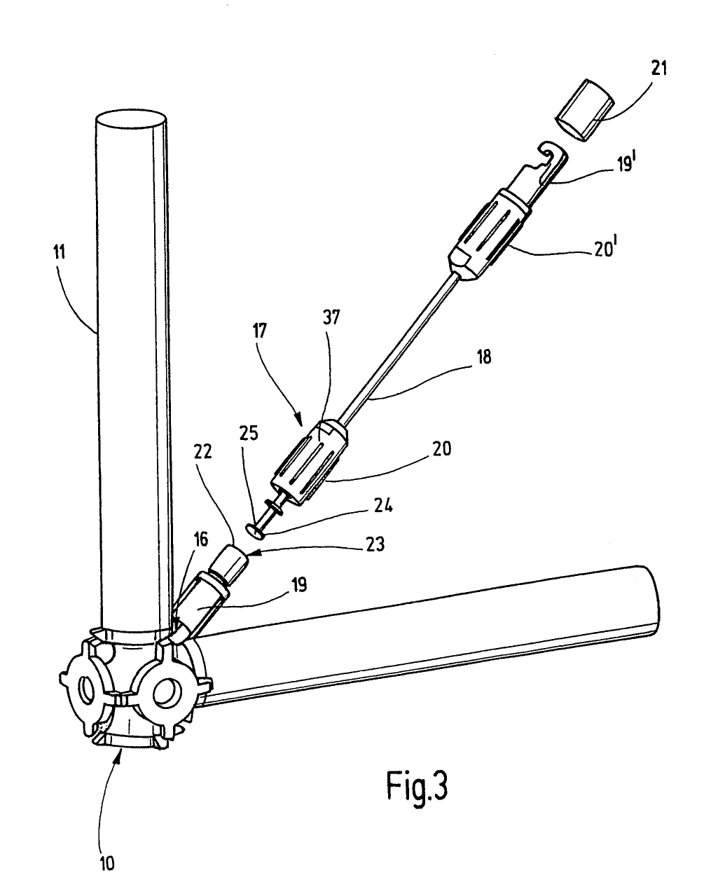

FIG. 3 depicts an alternative embodiment of the inventive supporting framework with diagonal bracing;

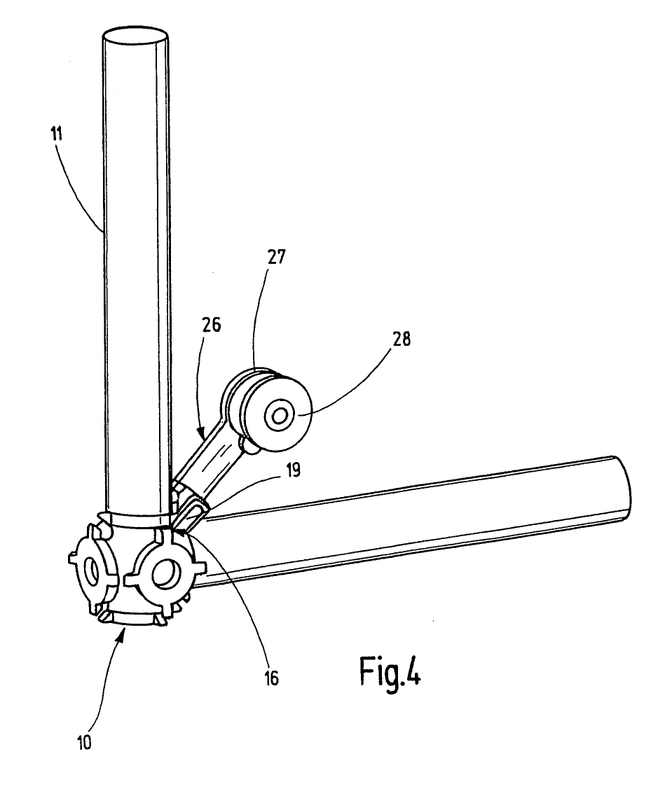

FIG. 4 depicts another alternative embodiment of the inventive supporting framework with a wall holder;

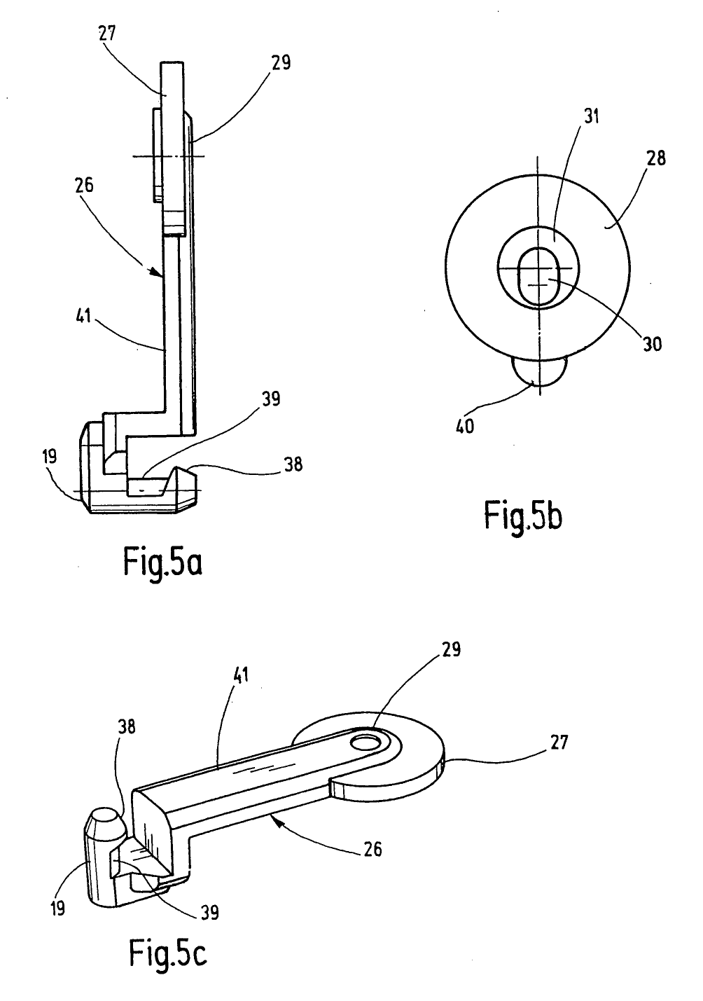

FIGS. 5a,b,c is a side elevation of a holding device for a wall element (FIG. 5a), a section through a partial element of the holding device (FIG. 5b), and a perspective view of the holding device (FIG. 5c).

FIG. 1a depicts a section through an inventive connection node 10, and FIG. 1b is a perspective view.

The connection node 10 has a basically spherical shape and has regularly distributed mating bores 32 into which struts (not shown) can be inserted. However, it is also possible to embody the connection node 10 as a cube with square lateral surfaces or as a polyhedron. On the surface of the sphere the mating bores 32 are surrounded by ring-shaped strut receiving elements 12, the rings being wider than they are high and each being disposed on adapters 33 of the mating holes 32, the adapters expanding outward circumferentially. Each strut receiving element 12 is arranged in the center of an imaginary cube face 13 of the connection node 10. Extending from the strut receiving elements 12 are arms 14, 14′ that are arranged cross-wise and that run parallel to edges 15 of the imaginary cube face 13 and parallel to this cube face 13 up to the edge 15 of the imaginary cube face 13. Associated with each strut receiving element 12 are four arms 14, 14′ distributed uniformly on the circumference, the arms 14 of each strut receiving element 12 meeting arms 14′ of adjacent, orthogonally arranged strut receiving elements 12, forming a loop 16 in each case. The connection node 10 has a total of six strut receiving elements 12, the arms of which form a total of twelve loops 16. The arms 14 can each remain spaced apart from one another. A hook-shaped connection element [not shown] can be hooked into each of the loops 16 in order for instance to produce a diagonal connection for the entire supporting framework.

FIG. 2 depicts one embodiment form of an inventive supporting framework with connection nodes 10, the structure of which is consistent with the description for FIGS. 1a and 1b. Identical elements have the same reference numbers in the figures. Struts 11 or extension pieces 34 for struts 11 can be inserted into the mating holes 32 or strut receiving elements 12 of the connection node 10, for instance using a plug-in connection or by screwing it in. It can also be provided that the connection between the struts 12 and the connection node 10 is magnetic, at least one strut 11 having a magnet in the area of its inserted free end, for instance, and an associated counterpart in the connection node 10 being ferromagnetic. As needed the struts 11 can be connected directly to the connection node 10 or can be connected via extension pieces 34. The extension pieces 34 have a bevel 35 that can act as a viewing hole and thus make it easier to check the stability of the connection. Where necessary a tool can also be inserted via the bevel 35. During assembly of the extension piece 34, an intermediate ring 36 can be added between the connection node 10 and the extension piece 34 for stabilizing the connection.

FIG. 3 depicts an alternative embodiment of an inventive supporting framework having a connection node 10, the structure of which is also consistent with the description for FIGS. 1 and 2. A diagonal strut 18 is provided for stabilizing the supporting framework, and it is attached to the connection node 10 by means of a connection element 17. The connection element 17 includes a hook element 19, 19′ arranged on both sides of the diagonal strut 18, a tensioning sleeve 20, 20′, and a fixing element 21, which are shown in an exploded depiction in FIG. 3. The hook element 19, 19′ of the connection element 17 is connected in a self-locking manner to the loop 16 of the connection node 10 and when loaded is under tension. The hook element 19, 19′ has, at its free end 22 that faces away from the connection node 10 when assembled, a receiving opening 23 into which the diagonal strut 18 can be inserted. The diagonal strut 18 in FIG. 3 is made of wire and has at each of its free ends 24 a cap-like expansion 25 that when assembled locks into the correspondingly embodied receiving opening 23 of the hook element 19, 19′. The connection element 17 and the diagonal strut 18 are mounted by means of the tensioning sleeves 20, 20′. On its surface, the tensioning sleeve 20, 20′ has a grip structure 37 to facilitate the manual tensioning process and to prevent slipping.

When assembled, the connection element 17 is enclosed by the fixing sleeve 21 to prevent the connection from spontaneously coming undone.

FIG. 4 depicts an alternative embodiment of an inventive supporting framework. Instead of a diagonal brace illustrated in FIG. 3, the connection element 17 is embodied as a holding device 26 for a wall element (not shown). In the same manner as described in the foregoing, the holding device 26 has a hook element 19 that is hooked into a loop 16 of a connection node 10. At a free end facing away from the hook element 19, the holding device 26 has a first disk-shaped element 27. In addition, a correspondingly dimensioned second disk-shaped element 28 is provided that, with the first disk-shaped element 27, embodies a clamping apparatus for a wall element (not shown).

FIGS. 5a, 5b, and 5c depict the precise structure of the holding device 26; FIG. 5a is a side elevation of the holding device 26 illustrated with a hook element 19, a bearing element 41, and a first disk-shaped element 27. The hook element 19 has a barb 38 that also makes it possible for the hook element 19 to lock in the loop (not shown]. An area 39 of the hook element 19 that faces the loop when assembled is embodied flattened on both sides, not round, in cross-section. This makes it possible to attain further retention of the hook element 19 in the loop if the latter is not completely closed, as is described in the foregoing. The hook element 19 is preferably configured such that it is self-supporting once it has been placed in the loop, in order to facilitate mounting of the flat elements. The first disk-shaped element 27 is arranged at a free end of the holding device 26 that faces away from the hook element 19. A base surface of the first disk-shaped element 27 is arranged transverse to the longitudinal extension of the hook element 19. The first disk-shaped element 27 has a central bore 29 for receiving a connection means [not shown].

FIG. 5b is a top view of a second disk-shaped element 28 that is embodied as a screw-in tensioning sleeve and that is dimensioned corresponding to the first disk-shaped element 27 and that has a tab 40 that can be used as an aid during assembly. Arranged in the second disk-shaped element 28 is a central bore 30 in which the connection means [not shown] is received and to which the disk-shaped element 27 can be connected. A wall element [not shown] provided with a corresponding bore can thus be clamped between the first and the second disk-shaped elements 27, 28. When assembled, plastic disks or tube sections [not shown] can be arranged between the wall element and the disk-shaped elements 27, 28. The bore 30 of the second disk-shaped element 28 is embodied as a longitudinal hole so that stabilization of the elements in all directions can advantageously be attained like a type of adapter. A central spacer 31 is arranged on the second disk-shaped element 28 around the longitudinal hole 30.

### LEGEND

10 Connection node
11 Struts
12 Strut receiving elements
13 Cube face
14, 14′ Arms
15 Edge
16 Loop
17 Connection element
18 Diagonal strut
19, 19′ Hook element
20, 20′ Tensioning sleeve
21 Fixing element
22 Free end
23 Receiving opening
24 Free end of 18
25 Expansion
26 Holding device
27 First disk-shaped element
28 Second disk-shaped element
29 Bore
30 Bore
31 Spacer
32 Mating bore
33 Adapter
34 Extension piece
35 Bevel
36 Intermediate ring
37 Grip structure
38 Barb
39 Area
40 Tab
41 Bearing element

1-19. (canceled)

20. Supporting framework comprising:
a connection node having at least two strut receiving elements, each strut receiving element being arranged centrally on an imaginary cube face of the connection node; and
a plurality of arms extending from each of the strut receiving elements, the arms disposed generally parallel to the edges of the imaginary cube face and extending up to an edge of the imaginary cube face that is perpendicular to the arms, the arms of one strut receiving element meet the arms of an adjacent strut receiving element arranged orthogonal thereto and form at least one loop;
whereby a connection element is hooked into the loop for producing a diagonal connection.

21. The supporting framework in accordance with claim 20, wherein the connection element can be brought into a self-locking connection with the said loop, which connection can be placed under tension when loaded.

22. The supporting framework in accordance with claim 20, wherein the connection element is provided for attaching a mountable diagonal strut.

23. The supporting framework in accordance with claim 20, wherein the connection element includes at least one hook element, at least one tensioning sleeve, and at least one fixing element.

24. The supporting framework in accordance with claim 23, wherein the hook element has at a free end facing away from the connection node when assembled, a receiving opening into which the diagonal strut can be inserted.

25. The supporting framework in accordance with claim 22, wherein the diagonal strut has an expansion at each of its free ends that locks in a correspondingly embodied receiving opening of the hook element when assembled.

26. The supporting framework in accordance with claim 20, wherein the connection element and the diagonal strut are connected by the at least one tensioning sleeve.

27. The supporting framework in accordance with claim 23, wherein the connection element is enclosed by the element when assembled.

28. The supporting framework in accordance with claim 24, wherein the diagonal strut is made of wire.

29. The supporting framework in accordance with claim 22, wherein the diagonal strut is a rod.

30. The supporting framework in accordance with claim 20, wherein the connection element is a holding device for a flat element.

31. The supporting framework in accordance with claim 30, wherein the holding device has a first disk-shaped element at a free end facing away from the connection element.

32. The supporting framework in accordance with claim 30, further comprising a second disk-shaped element that cooperates with the first disk-shaped element to define a clamping device for a flat element.

33. The supporting framework in accordance with claim 30, wherein the first disk-shaped element has a central bore for receiving a connection member.

34. The supporting framework in accordance with claim 33, wherein the second disk-shaped element includes a longitudinal hole.

35. The supporting framework in accordance with claim 32, further comprising a central spacer arranged on the second disk-shaped element.

36. A connection node for press-fit connection of struts of a supporting framework, the connection node comprising:
at least two strut receiving elements, each strut receiving element being arranged centrally on an imaginary cube face of the connection node;
whereby arms extend from the strut receiving elements and run parallel to the imaginary cube faces and extend up to an edge of the imaginary cube face; and
whereby the arms of one strut receiving element meet arms of an adjacent strut receiving element, arranged orthogonal thereto and form at least one loop.

37. A connection element for producing a diagonal connection between a connection node and struts of a supporting framework, the connection node comprising:
at least one hook element,
at least one tensioning sleeve; and
at least one fixing element.

38. A connection element for producing a holding device for a flat element, the connection element comprising:
at least one hook element; and
a first disk-shaped element; and a second disk-shaped element;
wherein the first and second disk-shaped elements cooperate to define a holding device for a flat element.
